(19) United States
(12) Patent Application Publication
(10) Pub. No.: US 2002/0119799 A1
(43) Pub. Date: Aug. 29, 2002

(54) Radio communication system

(76) Inventors: Timothy J. Moulsley, Caterham (GB); Matthew P.J. Baker, Canterbury (GB); Bernard Hunt, Redhill (GB)

Correspondence Address: PHILIPS ELECTRONICS NORTH AMERICAN CORP, 580 WHITE PLAINS RD, TARRYTOWN, NY, 10591, US

(21) Appl. No.: 10/078,979

(22) Filed: Feb. 19, 2002

(30) Foreign Application Priority Data
Feb. 23, 2001 (GB) 0104610.1

(51) Int. Cl. H04Q 7/20

(52) U.S. Cl. 455/525; 455/452; 455/561; 455/67.1; 455/67.6

(57) ABSTRACT

A radio communication system comprises a secondary station (110) having a plurality of communication channels (226a, 226b, 226c) with a plurality of primary stations (100a, 100b, 100c) for the transmission of data packets from one or more selected primary stations to the secondary station. The selection of primary station(s) is performed on the basis of a plurality of metrics, and may be performed in the secondary station, the primary stations, or shared between primary and secondary stations. Use of a plurality of metrics enables improved system behaviour.

The values of one or more metrics may be signalled to the secondary station by a primary station or vice-versa. Metrics may be pre-processed or combined before their value is signalled. The metrics may also be dynamic and depend in part on predictions of system behaviour.

The present invention relates to a radio communication system and further relates to primary and secondary stations for use in such a system and to a method of operating such a system. While the present specification describes a system with particular reference to the Universal Mobile Telecommunication System (UMTS), it is to be understood that such techniques are equally applicable to use in other mobile radio systems.

There is a growing demand in the mobile communication area for a system having the ability to download large blocks of data to a Mobile Station (MS) on demand at a reasonable rate. Such data could for example be web pages from the Internet, possibly including video clips or similar. Typically a particular MS will only require such data intermittently, so fixed bandwidth dedicated links are not appropriate. To meet this requirement in UMTS, a High-Speed Downlink Packet Access (HSDPA) scheme is being developed which may facilitate transfer of packet data to a mobile station at up to 4 Mbps.

In known radio communication systems, at any one time a MS generally communicates with a single Base Station (BS). During the course of a call the MS may wish to investigate transferring to another BS, for example when the quality of the communication link deteriorates as the MS moves away from its BS, or when the relative traffic loading of different cells requires adjusting. The process of transferring from one BS to another is known as handover.

In a system operating according to the current UMTS specifications, the MS maintains a list of BSs known as the “active set” with which it is expected that radio links of reasonable quality can be maintained. When the MS is in dedicated channel mode, and there are multiple BSs in the active set, the MS is in “soft handover” with the BSs in the active set. In this mode uplink transmissions are received by all BSs in the active set, and all BSs in the active set transmit substantially the same downlink information to the MS (typically the data and most of the control information would be the same, but power control commands could be different). A drawback of this “soft handover” approach is that the uplink and downlink transmission powers cannot be optimised for each individual radio link, as only one set of power control commands is transmitted in the uplink, while the power control commands transmitted over the downlink from different BSs may result in conflicting requirements for the uplink transmission power.

The normal soft handover procedure is particularly suitable for real time services such as voice links, where a continuous connection must be maintained. For packet data links, however, it can be advantageous to select the optimum BS for the transmission of each data packet to a MS, to allow for dynamically changing radio link and traffic conditions. Improved system throughput can be achieved if the selection of the optimum BS is made immediately prior to transmission of each packet, minimising the number of packets received in a corrupted state and also minimising total transmitted power per packet. As currently proposed, metrics like path loss and SIR (Signal-to-Interference Ratio) could be used by the MS to select which BS site should be used for transmission of downlink packets.

An object of the present invention is to provide an improved fast site selection mechanism.

According to a first aspect of the present invention there is provided a radio communication system having communication channels between a secondary station and a plurality of primary stations, the system further comprising site selection means for selecting one or more of the plurality of primary stations for transmission of data to the secondary station, wherein the site selection means is responsive to a plurality of metrics for determining the or each selected primary station for further data transmissions.

By using a plurality of metrics to select the best primary station or stations for data transmission, system capacity can be improved. The selection can be made by the secondary station, by one or more of the primary stations, or by a combined method. Metrics determined by a primary station may be signalled to a secondary station and vice-versa. Metrics can take the form of predicted values, based on current and previous information.

According to a second aspect of the present invention there is provided a primary station for use in a radio communication system having communication channels between a secondary station and a plurality of primary stations, the system further comprising site selection means for selecting one or more of the plurality of primary stations for transmission of data to the secondary station, wherein the site selection means is responsive to a plurality of metrics for determining the or each selected primary station for further data transmissions and wherein the primary station includes at least part of the site selection means.

According to a third aspect of the present invention there is provided a secondary station for use in a radio communication system having communication channels between the secondary station and a plurality of primary stations, the system further comprising site selection means for selecting one or more of the plurality of primary stations for transmission of data to the secondary station, wherein the site selection means is responsive to a plurality of metrics for determining the or each selected primary station for further data transmissions and wherein the secondary station includes at least part of the site selection means.

According to a fourth aspect of the present invention there is provided a method of operating a radio communication system having communication channels between a secondary station and a plurality of primary stations, the method comprising selecting one or more of the primary stations to transmit data to the secondary station, wherein the selection of primary stations is based on a plurality of metrics.

The present invention is based upon the recognition, not present in the prior art, that improved operation of a data transmission system is enabled by using a plurality of metrics to make a site selection decision.

Embodiments of the present invention will now be described, by way of example, with reference to the accompanying drawings, wherein:

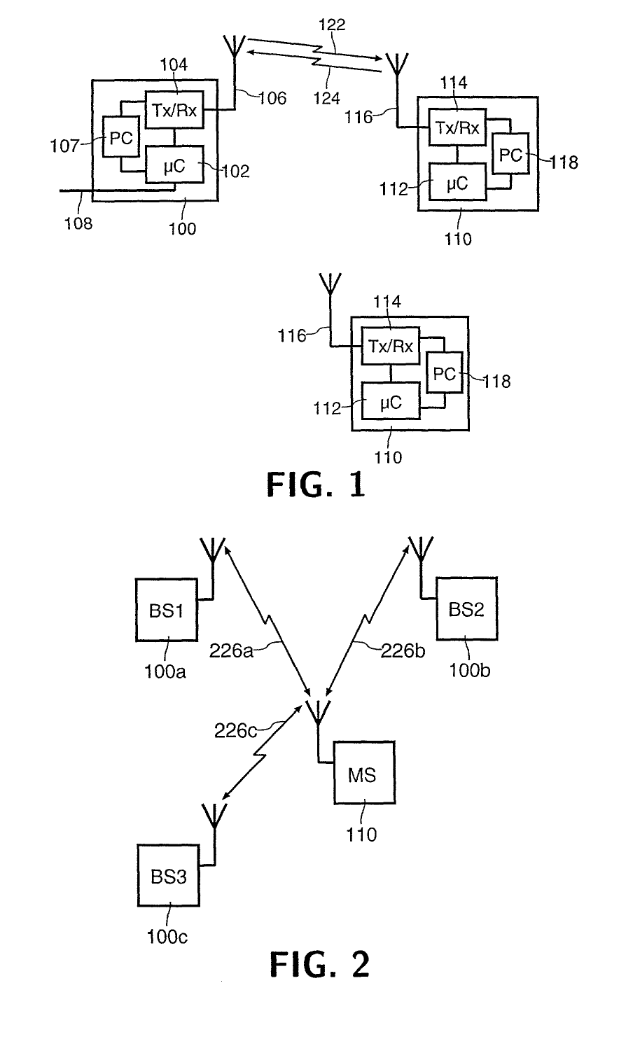

FIG. 1 is a block schematic diagram of a radio communication system; and

FIG. 2 is a block schematic diagram of a radio communication system with a MS in the process of soft handover.

In the drawings the same reference numerals have been used to indicate corresponding features.

Referring to FIG. 1, a radio communication system comprises a primary station (BS) 100 and a plurality of secondary stations (MS) 110. The BS 100 comprises a microcontroller (μC) 102, transceiver means (Tx/Rx) 104 connected to antenna means 106, power control means (PC) 107 for altering the transmitted power level, and connection means 108 for connection to the PSTN or other suitable network. Each MS 110 comprises a microcontroller (μC) 112, transceiver means (Tx/Rx) 114 connected to antenna means 116, and power control means (PC) 118 for altering the transmitted power level. Communication from BS 100 to MS 110 takes place on a downlink channel 122, while communication from MS 110 to BS 100 takes place on an uplink channel 124.

A MS 110 engaged in a soft handover process is illustrated in FIG. 2, the MS 110 having three two-way communication channels 226a,226b,226c, each comprising an uplink and a downlink channel, with three respective BSs 100a,100b,100c. In a given time slot the MS 110 receives substantially the same data from each of BSs 100a,100b,100c on the downlink channels, and transmits the same data to each of the BSs on the uplink channels. In a conventional UMTS system, each MS 110 receives power control commands determined individually by each of the BSs 100a,100b,100c in the active set, but only transmits one set of uplink power control commands to all BSs.

In a modified version of such a system, disclosed in our co-pending unpublished United Kingdom patent application 0103716.7 (Applicant's reference PHGBO10022), a MS 110 operates parallel power control loops with each of the BSs 100a,100b,100c. This modification is particularly useful for HSDPA, in which each data packet is transmitted to the MS 110 from one of the BSs 100a,100b,100c, because it enables selection of the best BS on a per-packet basis. Proposed embodiments of HSDPA use an ARQ (Automatic Repeat reQuest) technique to ensure correct delivery of each data packet, since accurate data transmission is viewed as more important than the reduced system throughput under poor channel conditions (due to multiple re-transmissions). In an embodiment of HSDPA disclosed in our co-pending unpublished United Kingdom patent application 0111407.3 (Applicant's reference PHGBO10069), signalling for site selection and ARQ is combined to improve system throughput and efficiency.

Proposed embodiments of a HSDPA system for UMTS employ a modified frame structure (with a duration which is a small sub-multiple of a standard 10 ms UMTS frame). The packet duration is the same as the frame duration. The frame structure has a data field for site selection information to indicate to the infrastructure which cell-site (or BS 100) should be used for transmission of the next packet. Typically this would be based on estimates of path loss or SIR derived from measurements of downlink common pilot channels transmitted from the potentially suitable BSs 100a,100b,100c.

However, the decision criteria outlined above can be sub-optimal. For example, if a particular BS 100 is already fully loaded, then it will not be able to transmit additional packets. Hence, there is no point in a MS 110 selecting that BS 100 as the transmission site.

A wide range of criteria could be used for site selection, for example:

minimising energy consumption of the MS 110 (per received bit);

maximising the average bit rate on the radio link (typically averaged over transmission periods only);

minimising average transmission delay (e.g. average time from start of first transmission to end of last re-transmission);

minimising the total interference likely to result from sending the packet;

maximising coverage area; and

maximising total system throughput.

The first five criteria can be evaluated for each radio link between a MS 110 and a BS 100a,100b, 100c, given some estimate of interference levels. The last, although clearly the most desirable, probably needs to be derived empirically for the whole system rather than per radio link or per MS 110.

If the power consumption of its receiver is the main factor in the energy consumption of the MS 110, this could be minimised by minimising the time the receiver needs to be active in order to correctly receive a packet (including any retransmissions). In this case the first two criteria are effectively the same, and may or may not be satisfied by minimising the number of retransmissions. Depending on the fading characteristics of the transmission channel and the particular ARQ scheme used, it could for example be better to send data at a relatively high bit rate, with some retransmissions, rather than sending it at a relatively low bit rate with no retransmissions.

The criteria used for site selection could change according to system loading. For example, in a fully loaded system minimisation of interference (with the aim of allowing higher throughput) could be considered the most important criterion, while in a lightly loaded system it would be reasonable to minimise delay or MS power consumption.

Some factors which would be relevant in computing values for the above criteria are, for each BS 100a,100b,100c (or Node B in a UMTS system):

path loss from the BS 100a,100b,100c to the MS 110 (which could be estimated from the transmit power required for other channels to the same MS 110);

available power for HSDPA at the BS;

channelisation code space available for HSDPA at the BS;

interference level at the MS 110;

traffic loading;

channel quality (for example the potential to support multiple paths using MIMO (Multi-Input Multi-Output) techniques);

MS location (in cells where the BS 100a,100b,100c, uses beamforming techniques); and

S power requirements (e.g. battery state).

The above are dynamic (time varying) quantities, so it could be desirable to predict them for the frame in which the next packet will be sent.

In addition to the dynamic parameters, a range of static parameters are relevant. These include the capabilities of the MS 110 (for example demodulation, decoding, buffer space for ARQ) and of the network (or BS 100a, 100b, 100c) (for example modulation, coding, buffer space for ARQ).

There may be also relevant semi-static parameters which would be constant over the period of a call, for example application requirements such as delay and error rate.

In general, if the MS 110 is making the site selection decision it would be desirable for the BS 100 to signal to the MS 110 the values of metrics it needs, but which it cannot otherwise measure. Similarly, the MS 110 could signal metric information to the BS 100 if the BS were making the decision. Some combinations of metrics might be pre-processed by combining them together before signalling. For example, a BS 100 might inform the MS 110 of the maximum bit rate that is currently available on HSDPA (which would depend on the power, channelisation code and modulation capability of the MS/BS combination). The values of metrics applicable to more than one MS 110 could be transmitted on a broadcast channel instead of being signalled individually to each MS 110.

A joint decision could be made by MS 110 and BS 100. One example would be that the MS 110 signals more than one candidate site to the BS 100 and the network chooses between them. This would typically require signalling between the BSs 100a, 100b, 100c.

The possibilities described above are now applied to example embodiments relating to the support of HSDPA in UMTS.

In a first scheme, the site selection decision is made at the MS 110. A known UMTS system is modified by broadcasting some new information (typically slowly varying) on the BCH (Broadcast CHannel) of each BS 100a, 100b, 100c. This information could include:

The modulation capability of the BS 100a, 100b, 100c (e.g. whether it supports 16-QAM and/or 64-QAM in addition to the usual QPSK).

The maximum power which the BS may currently use for HSDPA, relative to the power of the CPICH (Common Pllot CHannel). For example, if 10% of the power were allocated to CPICH, then up to 80% might be allocated for HSDPA, and the broadcast ratio would be “8”.

The maximum channelisation code space the BS 100a, 100b, 100c may currently allocate to HSDPA. This would identify the channelisation code(s) potentially available.

In addition to the above, additional new information (typically rapidly varying) is also broadcast on an additional physical layer channel, known as a “HSDPA Availability Indicator Channel” (HAICH) and which could be similar to a CSICH (CPCH Status Indicator Channel), as disclosed in our International Patent Application WO 01/10158. In this embodiment, the broadcast information would indicate the availability of HSDPA channelisation codes. In the general case the HAICH could be a multi-value signal indicating the number (or rather, predicted number) of available channelisation codes. The number of signalling bits could be reduced if the HAICH signal indicated the fractional availability of the channelisation codes signalled on the BCH. In the simplest case the HAICH could be a binary flag indicating whether the relevant BS 100a, 100b, 100c has spare capacity or not. In this last case the information on the BCH relating to channelisation codes would simply specify which codes might be used for transmission.

This information would enable the MS 110 to derive the maximum bit rate that the BS 100a, 100b, 100c could provide (assuming the maximum power was available).

The MS 110 should have been informed by higher layer signalling of the members of the set of BSs 100a, 100b, 100c that it is allowed to select from. It then makes a site selection. If the selection criterion is based on the maximum likely bit rate, then this could be computed for each BS from some or all of the following metrics:

measured CPICH power;

current maximum HSDPA power available (from BCH);

set of available modulation/coding schemes (from BCH);

number of channelisation codes available (from HAICH and available code space from BCH); and

measured total noise power (including interference from other BSs).

Assuming the maximum available power is used and some knowledge of the channel properties (e.g. fading characteristics) is available, the bit error rate can be calculated for each modulation/coding scheme and number of available channelisation codes. This leads to a packet failure rate and an estimate of the time needed to successfully send a packet (including retransmissions). For these purposes the bit rate is the number of bits sent in the packet, divided by the average time taken for all the required transmission periods. Finally, the BS 100a, 100b, 100c with the highest available bit rate would be selected, and its identity signalled to the BS 100. This could be done either by the physical layer, for example as disclosed in our co-pending unpublished United Kingdom patent application 0111407.3 (Applicant's reference PHGB010069), or with a higher layer signal.

The relevant BS(s) should have been informed of the MS 110 capabilities (including de-modulation capability) during set-up/activation of the HSDPA bearer. So packet transmission to the MS 110 can now be scheduled (either from the selected BS 100a, 100b, 100c, or possibly another one chosen by the network).

A second scheme is similar to the first with the exception that the HAICH indicates the fraction of the maximum possible power signalled on the BCH which is actually available (or expected to be available). In this case the selection would be based on a rapidly updated value of maximum power and a more slowly updated value of available channelisation codes. As a further variation it would be possible for the HAICH to carry information on the availability of both power and codes.

In a third scheme, the MS 110 would use any relevant information on the BCH and sent on the HAICH to derive some comparison metric (e.g. maximum possible bit rate) for each BS 100a, 100b, 100c. This metric could then be sent to the BS, which would make a decision to select a site (possibly after combining with further metrics known to the BS).

Alternatively, as a possibility which reduces the complexity of the MS 110 implementation, the MS could measure the power of the CPICH from each BS 100a, 100b, 100c and signal that to the BS. The network could then decide on the site from which the packet(s) would be sent.

As part of the scheduling process, the network would also need to select a modulation/coding scheme, one or more channelisation codes to be used and a power level. This could be done based on signalled measurements or using power control information. The data format could be indicated by means of a TFCI on a downlink control channel.

Although the embodiments described above have been in terms of a UMTS FDD system, the present invention is not restricted to use in such a system and may be applied in a wide range of systems, for example including TDD (Time Division Duplex).

In practice the amount of data transmitted before BS selection is performed again may be more than one packet, depending on the system overheads of changing the transmitting BS.

In the embodiments described above the data channel is transmitted to the MS 110 from one BS at a time. However, it may be advantageous in some circumstances for data channels to be transmitted simultaneously from more than one BS. For example, in a situation where three BSs 100a, 100b, 100c are under closed loop power control, if two of the BSs provide an equally good link quality, preferably with similar transmit powers, the data packet or packets may be transmitted concurrently from those two base stations (in a similar manner to transmissions during soft handover).

In a variation on the embodiments described above, there could be more than one data link between a primary and a secondary station. For example, the invention could be applied to selection between radio links at different frequencies even if they are between the same pair of stations, or to radio links using different antennas. As well as being used in site selection, the metrics described above could be used in the determination of properties of the downlink transmission, for example the choice of modulation coding scheme and the allocation of channel resources.

The description above related to the BS 100 performing a variety of roles relating to the present invention. In practice these tasks may be the responsibility of a variety of parts of the fixed infrastructure, for example in a “Node B”, which is the part of the fixed infrastructure directly interfacing with a MS 110, or at a higher level in the Radio Network Controller (RNC). In this specification the use of the term “base station” or “primary station” is therefore to be understood to include the parts of the network fixed infrastructure involved in an embodiment of the present invention.

From reading the present disclosure, other modifications will be apparent to persons skilled in the art. Such modifications may involve other features which are already known in the design, manufacture and use of radio communication systems and component parts thereof, and which may be used instead of or in addition to features already described herein.

In the present specification and claims the word “a” or “an” preceding an element does not exclude the presence of a plurality of such elements. Further, the word “comprising” does not exclude the presence of other elements or steps than those listed.

1. A radio communication system having communication channels between a secondary station and a plurality of primary stations, the system further comprising site selection means for selecting one or more of the plurality of primary stations for transmission of data to the secondary station, wherein the site selection means is responsive to a plurality of metrics for determining the or each selected primary station for further data transmissions.

2. A system as claimed in claim 1, characterised in that means are provided for determining at least one of the metrics dynamically.

3. A system as claimed in claim 1, characterised in that the site selection means is responsive to at least one of the following metrics: path loss between a primary station and the secondary station; available power for data transmissions at a primary station; available channelisation codes at a primary station; interference levels at the secondary station; traffic loading; channel quality; and secondary station power requirements.

4. A primary station for use in a radio communication system having communication channels between a secondary station and a plurality of primary stations, the system further comprising site selection means for selecting one or more of the plurality of primary stations for transmission of data to the secondary station, wherein the site selection means is responsive to a plurality of metrics for determining the or each selected primary station for further data transmissions and wherein the primary station includes at least part of the site selection means.

5. A primary station as claimed in claim 4, characterised in that the site selection means comprises signalling means for signalling information relating to the value of at least one metric to the secondary station.

6. A primary station as claimed in claim 5, characterised in that means are provided for pre-processing data relating to at least one metric before the information is signalled to the secondary station.

7. A primary station as claimed in claim 5, characterised in that means are provided for transmitting the value of at least some of the metrics to be signalled by the signalling means via a general-purpose broadcast channel.

8. A primary station as claimed in claim 5, characterised in that the system further comprises a metric broadcast channel and in that means are provided for signalling the value of at least some of the metrics to be signalled by the signalling means via the metric broadcast channel.

9. A primary station as claimed in claim 7, characterised in that a metric signalled via a broadcast channel relates to the availability of channelisation codes.

10. A primary station as claimed in claim 4, characterised in that the site selection means comprises means for receiving the value of at least one metric signalled by the secondary station.

11. A secondary station for use in a radio communication system having communication channels between the secondary station and a plurality of primary stations, the system further comprising site selection means for selecting one or more of the plurality of primary stations for transmission of data to the secondary station, wherein the site selection means is responsive to a plurality of metrics for determining the or each selected primary station for further data transmissions and wherein the secondary station includes at least part of the site selection means.

12. A secondary station as claimed in claim 11, characterised in that the site selection means comprises means for receiving the value of at least one metric signalled by a primary station.

13. A secondary station as claimed in claim 11, characterised in that the site selection means comprises means for determining the value of at least one metric and for signalling information relating to that metric to a primary station.

14. A secondary station as claimed in claim 13, characterised in that means are provided for pre-processing data relating to at least one metric before the information is signalled to the primary station.

15. A method of operating a radio communication system having communication channels between a secondary station and a plurality of primary stations, the method comprising selecting one or more of the primary stations to transmit data to the secondary station, wherein the selection of primary stations is based on a plurality of metrics.
